(19) United States
(12) Patent Application Publication
(10) Pub. No.: US 2010/0137033 A1
(43) Pub. Date: Jun. 3, 2010

(54) Illuminated Touch Sensitive Surface Module

(75) Inventor: Wen-Kai LEE, Hsin-Chu (TW)

Correspondence Address: LanWay IPR Services, P.O. box 223205, Chantilly, VA, 20153, US

(73) Assignee: ELAN MICROELECTRONICS CORP.

(21) Appl. No.: 12/618,941

(22) Filed: Nov. 16, 2009

Related U.S. Application Data
(60) Provisional application No. 61/118,527, filed on Nov. 28, 2008.

(30) Foreign Application Priority Data
Jun. 2, 2009 (TW) 098118271

(51) Int. Cl. H04B 1/38; G06F 3/041; G06F 3/045

(52) U.S. Cl. 455/566; 345/173; 345/174

(57) ABSTRACT

An illuminated touch sensitive surface module includes a sensor, an illuminated device and a controller. The sensor senses position information of hovering or touching objects, the illuminated device includes illuminated modes and one or more light guide films with characters, symbols or patterns, and the controller connects to the sensor and the illuminated device for controlling the illuminated modes of the illuminated device and the illumination of the light sources according to the position information.

### CROSS-REFERENCE

This application claims priority from U.S. Provisional Patent Application No. 61/118,527 filed on Nov. 28, 2008.

### BACKGROUND

The present invention relates to a touch sensitive surface module, and more specifically, to the illuminated touch sensitive surface module.

Due to the trends of thinness and fashion in the electronic devices such as laptop and touch-input mobile phone, the overall space for customerized utility is reduced and the software, firmware and hardware of the input interface to be integrated to develop a touch sensitive surface module or display with fancy and physical functions is need. For example, the electronic devices such as laptop and touch-input mobile phone usually equipped the physical or virtual buttons, operation regions and interfaces. Therefore, the touch sensitive surface module with straightforward operation fulfills the user's demand.

The touch sensitive surface module has widespread fields of application such as laptop, touch-input mobile phone, remote controller, input/output interface of an audio and video device. Although the touch sensitive surface module has multiple functions such as controlling a cursor of a GUI (Graphical User Interface), scrolling of a window and operating the virtual buttons, it seems inconvenient in operation since they can't identify the position or the boundary of touch sensitive surface easily in the dark environment. Accordingly, developing an illuminated touch sensitive surface module and electronic devices with auxiliary function in illumination and vision effect enhancement has become a research issue nowadays.

### BRIEF SUMMARY

It is therefore the objective of the present invention to provide an illuminated touch sensitive surface module integrating the light guide film and control of the light sources which illumination are adjustable according to the user's touch input for generating interactive illumination effect.

It is therefore another objective of the present invention to provide an illuminated touch sensitive surface module integrating the light guide film and control of the light sources for fulfilling the user's demands on direct single- and multi-object touch input.

In one preferred embodiment, an illuminated touch sensitive surface module of the present invention includes a sensor, an illuminated device and a controller. The illuminated device has a plurality of light guide films each including a bottom with at least one micro member and a light emitted out side for receiving the light beams of the light sources. The micro member changing the paths of entered light beams toward the light emitted out side.

The controller which is connected to the illuminated device for switching the light sources, determining the entered light guild film and switching different illuminated modes of the illuminated touch sensitive surface module accordingly, and the sensor and the illuminated device are stacked mutually.

In one preferred embodiment, an illuminated touch sensitive surface module of the present invention includes a cosmetic layer, a sensor, an illuminated device and a controller. The cosmetic layer is transparent, permitting the touch or the hover of an object and disposed a masking material with a preset masking ratio.

The sensor senses the position information of the touching or hovering objects, and the illuminated device having a light guide film, a plurality of light sources and a plurality of sub-regions. The bottom of the light guide film including a plurality of micro members responsive to the sub-regions receives the light beams of the light sources, and the micro members change the paths of the light beams inside the light guide film toward the cosmetic layer and then provide the illuminated mode of the illuminated device.

The controller is connected to the illuminated device and adjusts the light sources according to the position information for activating the higher illumination of the sub-regions in accordance with the position information than the preset masking ratio and the lower illumination of the remained sub-regions than the preset masking ratio. The cosmetic layer, the sensor and the illuminated device are stacked.

In one preferred embodiment, the electronic device includes a housing and an illuminated touch sensitive surface module. The illuminated touch sensitive surface module is set inside the housing and includes a sensor, an illuminated device and a controller. The illuminated device has a plurality of light guide films and light sources, and each of the light guide films includes a bottom on which at least one micro member is set for and a light emitted out side for receiving the light beams of the light sources. The micro member changes the paths of entered light beams toward the light emitted out side.

The controller is connected to the illuminated device for switching the light sources, determining the entered light guild film and switching different operating modes of the illuminated touch sensitive surface module accordingly, and the sensor and the illuminated device are stacked mutually.

According to the integration of the sensor, the illuminated device and the micro members, the switch and the magnitude of illumination and emitting and reflecting of the light beams are under controlling and interactive with user's single- and multi-touch.

In addition, it is convenient and cost saving through changing the type of the micro member on the light guide film of the illuminated device and controlling the light source of corresponding light guild film to switch the vision effects such as different patterns, characters, alphabets, symbols, colors and illumination during different operation modes.

Furthermore, it provides the indication through the setting rules of the micro members, different illumination of the light sources and the host software so that the user may operate desire function of the touch sensitive surface module using the gestures such as one click and double clicks more easily, and the application field of the touch sensitive surface module is broaden.

For further understanding of these and other objectives, the nature and advantages of the invention, reference should be made to the following description taken in conjunction with the accompanying drawings.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is an exploded view of an illuminated touch sensitive surface module in accordance with a preferred embodiment of the present invention.

FIG. 2 is an exploded view of an illuminated touch sensitive surface module in accordance with an alternative preferred embodiment of the present invention.

FIG. 3A schematically illustrates a first light guide film of an illuminated device in accordance with a preferred embodiment of the present invention.

FIG. 3B schematically illustrates a second light guide film of an illuminated device in accordance with an alternative preferred embodiment of the present invention.

FIG. 4A is a sectional view of an illuminated touch sensitive surface module in accordance with a preferred embodiment of the present invention.

FIG. 4B is a sectional view of an illuminated touch sensitive surface module in accordance with an alternative preferred embodiment of the present invention.

FIG. 5 schematically illustrates an allocation of the micro members in accordance with a preferred embodiment of the present invention.

FIGS. 6A and 6B schematically illustrate the illumination of the light sources in accordance with a preferred embodiment of the present invention.

FIGS. 7A and 7B schematically illustrate a touch-input mobile communication device in accordance with a preferred embodiment of the present invention.

### DETAILED DESCRIPTION

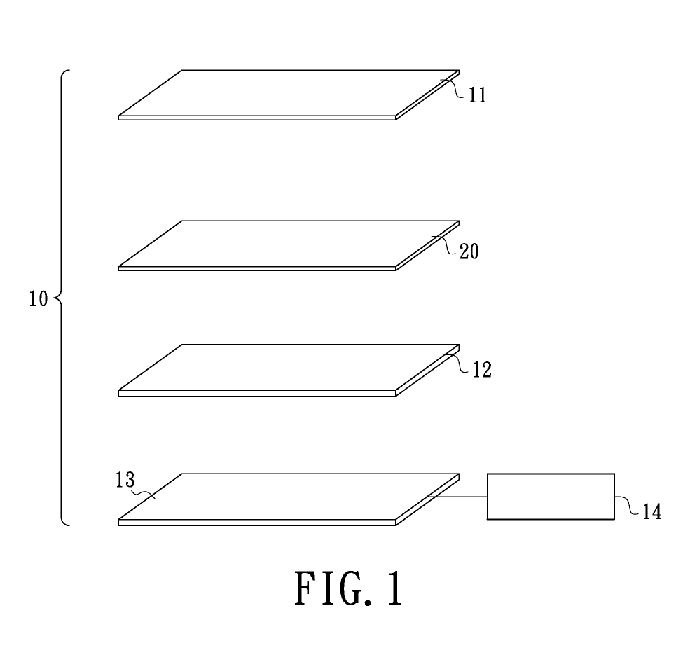

The present invention provides several embodiments of the illuminated touch sensitive surface module having fancy light effects and touch functions. As shown in FIG. 1, the touch sensitive surface module 10 includes stacked cosmetic layer 11, reflecting layer 12, an illuminated device 20, a sensor 13 and a controller 14.

The cosmetic layer 11 permits the touch or the hover of finger and other conductive objects, protects the illuminated device 20, the reflecting layer 12 and the sensor 13 and diffuses the light beams of the illuminated device 20. In one embodiment, the cosmetic layer 11 is transparent, disposed a masking material and has a preset masking ratio for filtering or absorbing the light beams. The masking material may be disposed on the surface or the bottom capable of preventing the scrap during operating or using for a long time. Therefore, when the illumination of parts of or entire regions is lower than the preset masking ratio, they are not illuminated because the light beams cannot pass through the cosmetic layer 11.

The reflecting layer 12 is set between the sensor 13 and the illuminated device 20 for spread the light beams emitted from the light sources, and it is a single element or an insulating paint painted on the sensor 13. In alternative embodiment, the reflecting layer 12 may be omitted.

The sensor 13 senses a hover or a touch of objects such as fingers and stylus, and it is capacitive, resistant or magnetic-induced. The position information sensed is one-, two- or multi-dimension coordinates to the controller 14. The controller 14 drives corresponding illuminated modes and illumination according to the position information. For instance of the capacitive sensor, the sensor 13 includes a printed circuit board such as flexible printed circuit board on which the traces or the electrodes are formed for sensing the hover or the touch of objects.

The controller 14 is connected to the illuminated device 20, and the cosmetic layer 11, the sensor 13 and the illuminated device 20 are stacked. The controller 14 receives an output signal of the sensor 13 and drive corresponding application program, pulse width modulation, illuminated modes and operating modes.

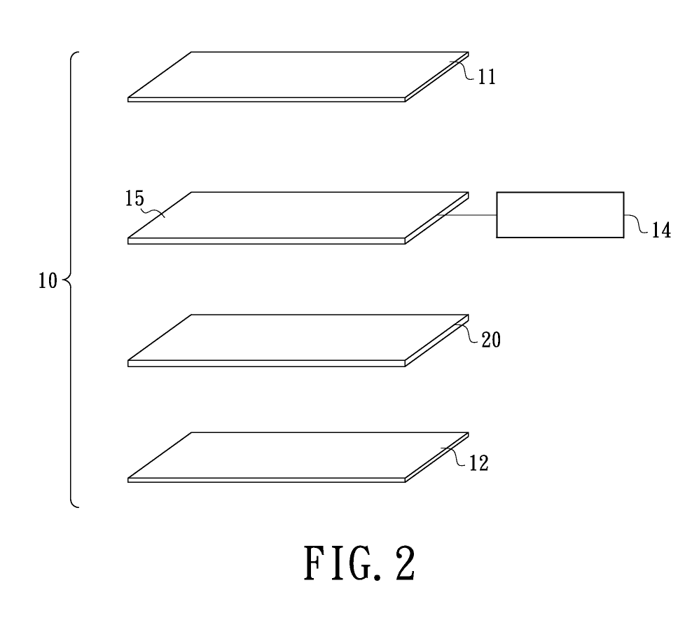

FIG. 2 is an exploded view of an illuminated touch sensitive surface module in accordance with an alternative preferred embodiment of the present invention. In the embodiment, the transparent sensor 15 is an ITO (Indium Tim Oxide) sensor. Due to the feature of transparency, the reflecting layer 12 and the illuminated device 20 are assembled closer to the sensor 15 so that the characters, symbols or patterns of the light guide film are displayed on the cosmetic layer 11 for providing the operating modes. In practice, the transparent sensor 15 is not intended to be limited to set above the illuminated device 20.

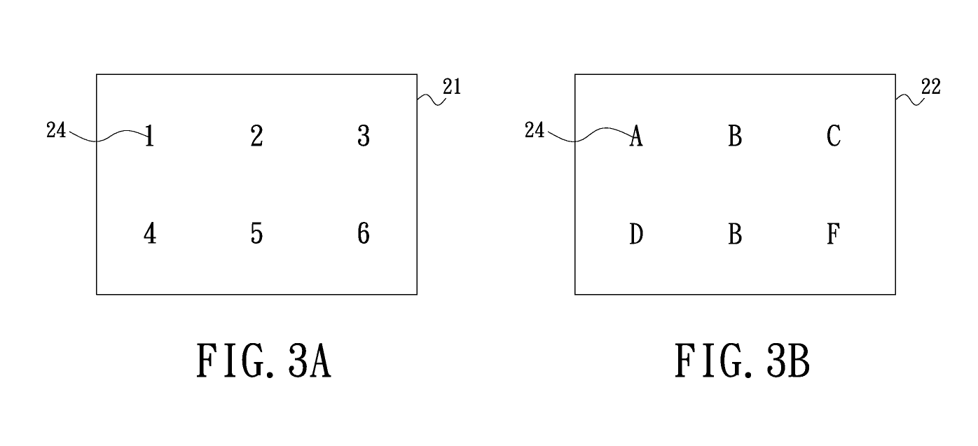

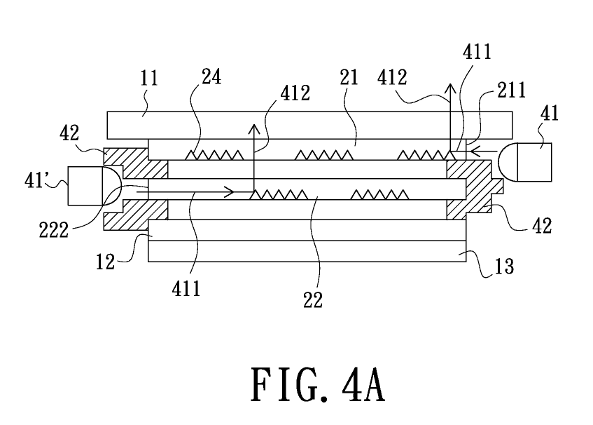

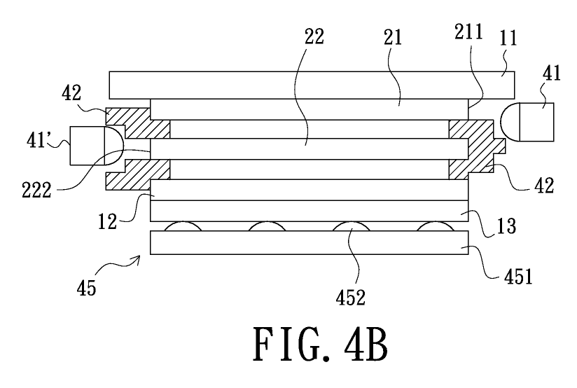

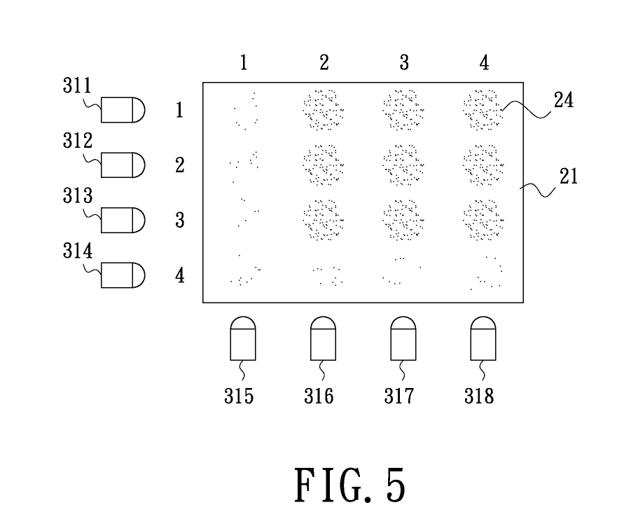

Please refer to FIGS. 3A, 3B and 4A. In an embodiment, the illuminated device 20 is set between the cosmetic layer 11 and the sensor 13 or the reflecting layer 12 if exists, and it includes the light guide film 21 and 22, light source 41 and 41′ and illuminated modes. In an alternative embodiment, the light guide films includes a first light guide film 21 and a second light guide film 22, and the light beams of the light source 41 and 41′ are entered through a first side 211 of the light guide film 21 and the second side 222 of the light guide film 22. The micro members are set on the bottoms of the light guide film 21 and 22 for changing paths of entered light beams toward the light emitted out side, the same direction as that of the cosmetic layer 11), and that is the light guide film 21 and 22 change the paths of entering light beams 411 to that of the outward light beams 412.

FIGS. 3A and 3B schematically illustrate the light guide films of an illuminated device in accordance with a preferred embodiment of the present invention. The micro members 24 are the micro structures generated by screening printing or laser, and the shape of micro member 24 is round or other shape which is capable of changing the path of the entering light beam 411 and obtaining the outward light beams 412. The path of the entering light beam 411 entered the region having no micro member 24 of the first light film 21 is remained, and it is changed and then generating an outward light beam 412 when the entering light beam 411 encountered the micro member 24.

In the embodiment, the number of light guide film of the illuminated device 20 is adjustable, and the characters, the symbols or the digits are set in the inter- or the intra-layer or the surface of the illuminated device 20. The micro members 24 may be formed as the shape of the characters, symbols or digits, and the density, position, number or shape of the micro members 24 may be different. In the embodiment, the first light guide film 21 as shown in FIG. 3A is set with digits as the first operating mode displayed in the cosmetic layer 11, and the second light guide film 22 as shown in FIG. 3B is set with English alphabet as the second operating mode displayed in the cosmetic layer 11.

The switch of light sources 41 and 41′ by the controller 14 controls the light beams entering to the light guide film 21 or 22 and then presenting different illuminated modes. Therefore, different vision effects in different switch modes are obtained through the allocation of the micro members 24 of the light guide films. In the embodiment, the light guide films are first light guide film 21 and the second light guide film 22.

As shown in FIG. 3A, the micro member 24 on the bottom of the first light guide film 21 is allocated as a shape of digit 1 to 6, whereas the micro member 24 on the bottom of the second light guide film 22 is allocated as a shape of English alphabet A to F as shown in FIG. 3B.

The first light guide film 21 and the second light guide film 22 are stacked after assembling the illuminated touch sensitive surface module 10, and a plastic support is set between them if they are large. The first light guide film 21 and the second light guide film 22 have private light source 41 and 41′ such as a LED (Light Emitting Diode). Moreover, the first light source 41 is in accordance with the first light guide film 21 and connected to a block member 42 such as sponge or adhesive for blocking the light beam of the first light source 41 entering to the second light guide film 22. Similarly, the second light source 41′ is in accordance with the second light guide film 22 and connected to another block member 42 such as sponge or adhesive for blocking the light beam of the second light source 41′ entering to the second light guide film 22. In the embodiment, the reflecting layer 12 is an insulating paint painted on the sensor 13.

Therefore, when lighting up the first light source 41 and putting out the second light source 41′, the path of the light beam entering to the first light guide film 21 is changed because of the micro member 24 on the first light guide film 21, and the illuminated device 20 only illuminates number 1 to 6 as the first operating mode. Similarly, when lighting up the second light source 41′ and putting out the first light source 41, the path of the light beam entering into the second light guide film 22 is changed because of the micro member 24 on the second light guide film 42, and the illuminated device 20 only illuminates English alphabet A to F as the second operating mode.

In addition, performing various vision effects of different color or illumination in different operating mode is achieved through changing the color, illumination, and so on.

Accordingly, it provides the convenient operations and reduces the producing cost through changing the configuration of the micro member 24 of the light guide film 21 and 22, using at least two stacked light guide films and switching the light source such as LED in accordance with each light guide film. For instance, user may switch the vision effects such as different figures, characters, numbers, symbols, colors or illumination between different operating modes.

FIG. 4B is a sectional view of an illuminated touch sensitive surface module in accordance with an alternative preferred embodiment of the present invention. In an embodiment, the illuminated touch sensitive surface module further includes a tactile switch device 45 set under the sensor 13 for providing a tactile sense of press and a circuit board 451 and the switches 452 such as metal dome set in the operation region in accordance with each operating mode. The metal dome 52 is a dome-shape flexible shell set in the position in accordance with the operating region having the physical or virtual button and presenting the operating mode of the cosmetic layer 11. The metal dome 52 is pressed down and then the part of the dome touches the circuit board 51 when user operates the operating region.

The layout of the circuit board 51 is in accordance with the metal dome 52. The part of the dome and the circumference of the bottom of the metal dome 52 form a short circuit when the part of the dome is pressed to touch the circuit board 51. Consequently, the flexible metal dome 52 is recovery so that the part of the dome and the circumference of the bottom of the metal dome 52 form an open circuit after releasing the pressure on the pressed part of the dome. Therefore, it acts as the switch and further provides the tactile sense and the function of input.

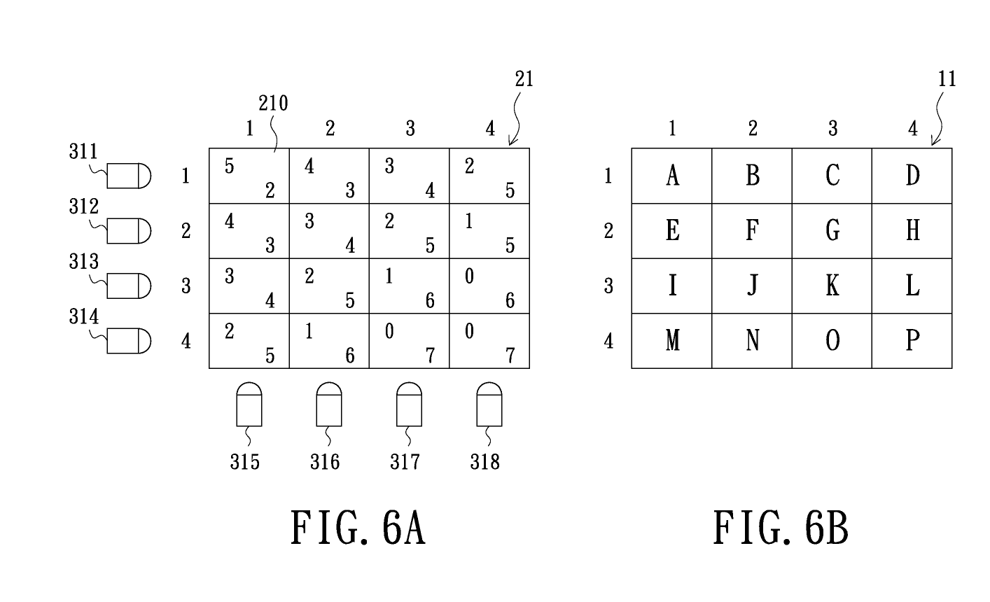

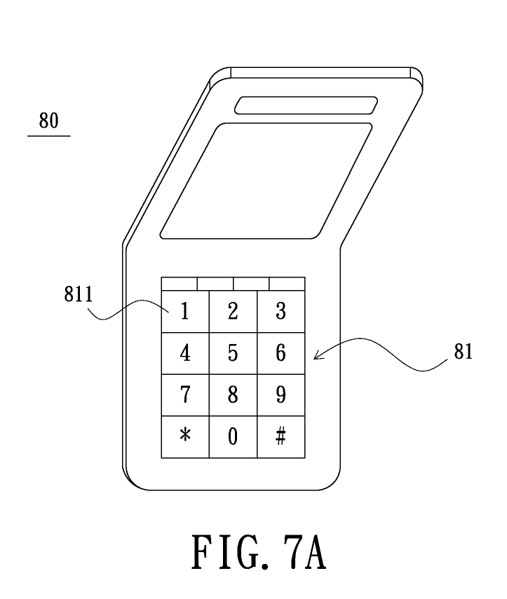

FIG. 5A illustrates an allocation of the micro members in accordance with a preferred embodiment of the present invention, and FIGS. 6A and 6B illustrate the illumination of the light sources in accordance with a preferred embodiment of the present invention. In the embodiments, the first light guide film 21 is partitioned into several sub-regions such as 16 sub-regions 210 when it is partitioned into four by four, and two adjacent sides of the first light guide film 21 have LED 311 to 318 in accordance with each column and row. The regional illumination is achieved through adjusting the illumination or/and the density of the micro member 24 for fulfilling the feature of decay of illumination.

The embodiment of FIG. 5 adjusts the density of the micro members 24 of the first light guide film so that the density of the micro members 24 of the sub-region 210 closer to the LED 311 to 318 is higher, whereas that of the sub-region 210 far from the LED 311 to 318 is lower. The micro member 24 changes the path of entering light beams to the direction of the cosmetic layer 11 for providing the illuminated modes of the illuminated device, and the regional illumination is resulted from the adjusted sub-regions 210 with different illumination according to the distance and the density of the micro member 24 and the light source with fixed illumination.

The embodiment of FIGS. 6A and 6B control the illumination of LED 311 to 318 by the controller but fix the density of the micro member 24, and the regional illumination is resulted from the sub-regions 210 with different illumination in accordance with the change of the illumination of the light source.

In the embodiment of FIG. 6A, the illuminating level of the LED 311 to 314 in accordance with row 1 to 4 are driven to the illumination 5, 4, 3 and 2 respectively by a PWM (Pulse Width Modulation). The higher the illuminating level, the higher the driving frequency and the illumination. Similarly, the illuminating level of the LED 315 to 318 in accordance with columns are driven to the illumination 5, 6, 7 and 7 respectively.

Due to the degradation of illumination, the illumination level 5, 4, 3 and 2 of the sub-regions 210 of the first row are labeled in the upper-left respectively and that of the first column are 2, 3, 4 and 5 labeled in the upper-right respectively when the LED 311 and 315 are lighted up simultaneously. Therefore, the sum of the illumination of the sub-regions 210 of the first column and row is 7 while the others are all lower than 6. The illumination of the first column and second, third and fourth row are 3, 4 and 5, and the illumination of the second, third and fourth column and first row are 4, 3 and 3. Employing the one-unit diffusion to all the sub-regions 210 through the cosmetic layer 11 disposed a masking material having the preset masking ratio equalizes the illumination to 6. Hence, differentiating the illumination of different sub-regions 210 for generating various effects, such as displaying the English alphabets A to D of the first row shown in FIG. 6B or displaying English alphabets A only, is achieved by filtering the sub-regions having the illumination lower than 6 via the cosmetic layer 11.

Accordingly, it illuminated the sub-region having the outward light beams 412 which illumination larger than the preset masking ratio of the cosmetic layer 11 through the setting rules of the micro members and different illumination of the light sources. In addition, it displays the preset operating modes on the cosmetic layer 11 as the indication through the illuminated sub-region 210 and the host software so that the user may operate desire function of the touch sensitive surface module using the gestures such as one click and double clicks more easily and press the tactile switch device set under the illuminated device 20, and thus the application field of the touch sensitive surface module is broaden and not limited to be a substitution for the mouse device.

Moreover, it is convenient and cost saving in implementing different operating modes with different colors, illumination, figures, characters, digits, symbols through changing the color and illumination of the LED.

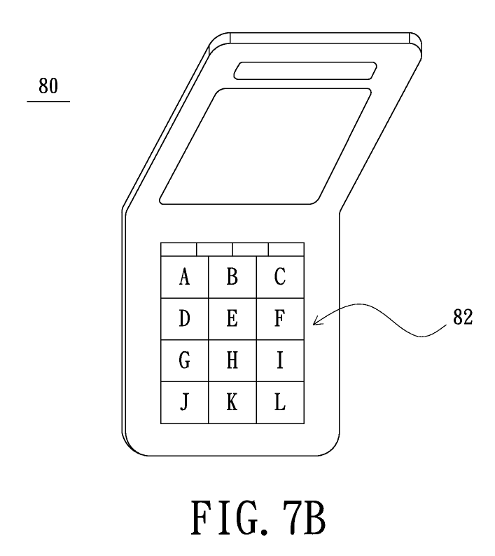

Please refer to FIGS. 7A and 7B illustrating a touch-input mobile communication device in accordance with a preferred embodiment of the present invention and FIG. 2. In the embodiment, the electronic device 80 includes a housing and an illuminated touch sensitive surface module 10. The illuminated touch sensitive surface module 10 is set inside the housing and includes a cosmetic layer 11, an illuminated device 20, a transparent sensor 15 and a controller 14. It's noted that the reflecting layer 12 shown in FIG. 2 may be omitted, and the sensor 15 is either a capacitive, a resistant or a magnetic-inductive sensor.

The cosmetic layer 11 displays various operating modes, provided for touching or hovering by user's fingers or other conductive objects and protects the illuminated device 20 and the sensor 15. The transparent cosmetic layer 11 diffuses filters or absorbs the light beams due to a preset masking ratio resulted from a disposed masking material.

The transparent sensor 15 such as an ITO sensor connected to the controller 14 senses a touch or a hover of objects, and the controller 14 drives illuminated modes and illumination of the illuminated device 20 according to the position information so that the light beams enter to one of the light guide films and switch different operating modes of the illuminated touch sensitive surface module.

Accordingly, the illuminated device 20 with the illuminated modes is set under the sensor 15 and includes one or more light guide films. The characters, symbols, digits or firm's LOGO are set in the inter- or the intra-layer or the surface of each light guide film. The micro members are set on bottom of the light guide film for reflecting the entering light beams encountering the micro member to the outward light beams, and the density, position, number and shape of the micro members may different according to the practice. In addition, the illumination is adjusted to that larger than the preset masking ratio of the cosmetic layer 11 when the illuminated device 20 is in the illuminated mode, and the characters, symbols or patterns are displayed on the cosmetic layer 11 as the operating modes 81 and 82.

The first light guide film of the illuminated device 20 has the digit 1 to 9 and the symbol “*” and “#” displayed entirely as the first operating mode 81 dialed by user during the illuminated mode in the embodiment. In alternative application, it may only display the digit “1” in a sub-region 811 shown in FIG. 7A. In addition, the second light guide film has English alphabets displayed entirely as the second operating mode 82 operated by user in the embodiment.

The illuminated device has the light guide films and light sources, and each of the light guide films includes a bottom on which at least one micro member is set for and a light emitted out side for receiving the light beams of the light sources. The micro member changes the paths of entered light beams toward the light emitted out side

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. An illuminated touch sensitive surface module, comprising:
a sensor;
an illuminated device having a plurality of light guide films and light sources, each of the light guide films including a bottom and a light emitted out side for receiving the light beams of the light sources, wherein at least one micro member changing the paths of entered light beams toward the light emitted out side is set on the bottom; and
a controller, connected to the illuminated device, switches the light sources, determines the entered light guild film and switches different illuminated modes of the illuminated touch sensitive surface module accordingly;
wherein the sensor and the illuminated device are stacked mutually.

2. The illuminated touch sensitive surface module of claim 1, wherein the light guild films include a first light guide film and a second light guide film stacked; the first side of the first light film and the second side of the second light guide film have a mask member respectively, and the first side and the second side are different side.

3. The illuminated touch sensitive surface module of claim 1, further comprising:
a cosmetic layer for permitting the touch or the hover of an object, wherein the cosmetic layer, the sensor and the illuminated device are stacked.

4. The illuminated touch sensitive surface module of claim 3, wherein the sensor set between the cosmetic layer and the illuminated device is transparent.

5. The illuminated touch sensitive surface module of claim 3, wherein the illuminated device is set between the cosmetic layer and the sensor.

6. The illuminated touch sensitive surface module of claim 1, further comprising:
a tactile switch device set under the illuminated device for providing a tactile sense of press.

7. The illuminated touch sensitive surface module of claim 6, wherein the tactile switch device includes a circuit board and a plurality of switches.

8. The illuminated touch sensitive surface module of claim 1, wherein at least one of the density, position, number and shape of the micro members is different.

9. The illuminated touch sensitive surface module of claim 1, wherein the micro members are the micro structures generated by screening printing or laser.

10. The illuminated touch sensitive surface module of claim 1, further comprising:
a reflecting layer set between the light guide films and the sensor.

11. The illuminated touch sensitive surface module of claim 1, wherein the sensor is one of a capacitive, a resistant and a magnetic-inductive sensor sensing the touch or the hover of an object.

12. An illuminated touch sensitive surface module, comprising:
a cosmetic layer disposed a masking material with a preset masking ratio;
a sensor;
an illuminated device having a light guide film, a plurality of light sources and a plurality of sub-regions; a bottom of the light guide film including a plurality of micro members for receiving the light beams of the light sources, wherein the micro members are responsive to the sub-regions for changing the paths of the light beams inside the light guide film toward the cosmetic layer and then providing an illuminated mode of the illuminated device; and
a controller, connected to the illuminated device, adjusts the light sources to activate the higher illumination of parts of the sub-regions and to lower the illumination of the remained sub-regions than the preset masking ratio;
wherein the cosmetic layer, the sensor and the illuminated device are stacked.

13. The illuminated touch sensitive surface module of claim 12, wherein at least one of the density, position, number and shape of the micro members is different.

14. The illuminated touch sensitive surface module of claim 12, wherein the illumination is adjusted using pulse width modulation.

15. The illuminated touch sensitive surface module of claim 12, wherein the sensor is one of a capacitive, a resistant and a magnetic-inductive sensor sensing the touch or the hover of an object.

16. The illuminated touch sensitive surface module of claim 12, wherein the cosmetic layer is transparent and permitting the touch or the hover of an object, the sensor senses a position information of the touching or hovering object, and the controller adjusts the light sources according to the position information to activate the higher illumination of the sub-regions in accordance with the position information than the preset masking ratio.

17. The illuminated touch sensitive surface module of claim 12, further comprising:
a tactile switch device set under the illuminated device for providing a tactile sense of press, wherein the tactile switch device includes a circuit board and a plurality of switches.

18. An electronic device, comprising:
a housing; and
an illuminated touch sensitive surface module set inside the housing, further comprising:
a sensor;
an illuminated device having a plurality of light guide films and light sources, each of the light guide films including a bottom and a light emitted out side for receiving the light beams of the light sources, wherein at least one micro member changing the paths of entered light beams toward the light emitted out side is set on the bottom; and
a controller, connected to the illuminated device, switches the light sources, determines the entered light guild film and switches different operating modes of the illuminated touch sensitive surface module accordingly;
wherein the sensor and the illuminated device are stacked mutually.

19. The electronic device of claim 18 is a touch-input mobile communication device.

20. The electronic device of claim 18, wherein the sensor is one of a capacitive, a resistant and a magnetic-inductive sensor sensing the touch or the hover of an object.
